(19) United States
(12) Patent Application Publication
(10) Pub. No.: US 2010/0118033 A1
(43) Pub. Date: May 13, 2010

(54) SYNCHRONIZING ANIMATION TO A REPETITIVE BEAT SOURCE

(75) Inventor: Matthew W. Faria, Cambridge, MA (US)

Correspondence Address: VISTA PRINT USA, INC.;ATTN: PATENT COUNSEL, 95 HAYDEN AVENUE, LEXINGTON, MA, 02421, US

(73) Assignee: VistaPrint Technologies Limited

(21) Appl. No.: 12/268,376

(22) Filed: Nov. 10, 2008

(51) Int. Cl. G06T 15/70

(52) U.S. Cl. 345/473

(57) ABSTRACT

An animated dance is made up of a plurality of frames. The dance includes a plurality of different moves delineated by a set of synchronization point. A total number of frames for the video track is determined and a corresponding video track is generated such that the resulting video track is synchronize at the synchronization points to beats of the audio track.

### BACKGROUND

The present invention pertains generally to computer animation, and more particularly to techniques for synchronizing animation to a repetitive beat source.

A video includes a video track and an associated audio track which are simultaneously output to a display and to one or more speakers, respectively. Certain visual content, such as dances, have a natural beat which is more aesthetically pleasing when synchronized to the beat of a musical audio track. However, often the natural beat of the dance is not naturally synchronized to the natural beat of the music.

### SUMMARY

Embodiments of the invention include methods and systems for generating video tracks that are synchronized to audio tracks.

In one embodiment, a method determines a number of frames of animation given a set of synchronization points in an animation specification and a selected audio track. The method includes steps of obtaining a fixed number of beats per time unit; obtaining a fixed number of frames per time unit; obtaining a segment size corresponding to a greatest common denominator of each of the percentages of the positions of the synchronization points in the animation specification relative to the entire animation specification; obtaining an ideal number for the total number of frames for the video track based on the desired duration of the video track and the fixed number of frames per time unit; performing estimation maximization to find a total number of frames required in the video track such that each of the synchronization points aligns with a beat of the selected audio track when the video track and the selected audio track are played simultaneously.

In another embodiment, a computer readable storage medium stores program instructions which, when executed by a computer, perform the method.

In another embodiment, an apparatus includes a synchronizer which determines a number of frames of animation given a set of synchronization points in an animation specification, a selected audio track, a fixed number of beats per time unit, a fixed number of frames per time unit, a segment size corresponding to a greatest common denominator of each of the percentages of the positions of the synchronization points in the animation specification relative to the entire animation specification, and an ideal number for the total number of frames for the video track based on the desired duration of the video track and the fixed number of frames per time unit. The apparatus includes a processor and memory which stores computer readable program instructions which perform estimation maximization to find a total number of frames required in the video track such that each of the synchronization points aligns with a beat of the selected audio track when the video track and the selected audio track are played simultaneously.

### BRIEF DESCRIPTION OF THE DRAWINGS

FIG. 1 is a perspective view of a user watching a video and listening to a synchronized audio track using a computer.

FIG. 2 illustrates a sequential set of frames that may be implemented in a video track;

FIG. 3 is an example musical score and corresponding beat timeline;

FIG. 4 is a timeline of the synchronization points of an example dance;

FIG. 5 is a flowchart illustrating an exemplary method for determining the number of frames of animation given the designated synchronization points and selected audio track;

FIG. 6 is a block diagram illustrating an exemplary apparatus for determining the number of frames of animation given the designated synchronization points and selected audio track;

FIG. 7 is a client-server system illustrating an exemplary electronic animated greeting card environment; and

FIG. 8 is an exemplary web page illustrating client selections of an audio track for a selected video track.

### DETAILED DESCRIPTION

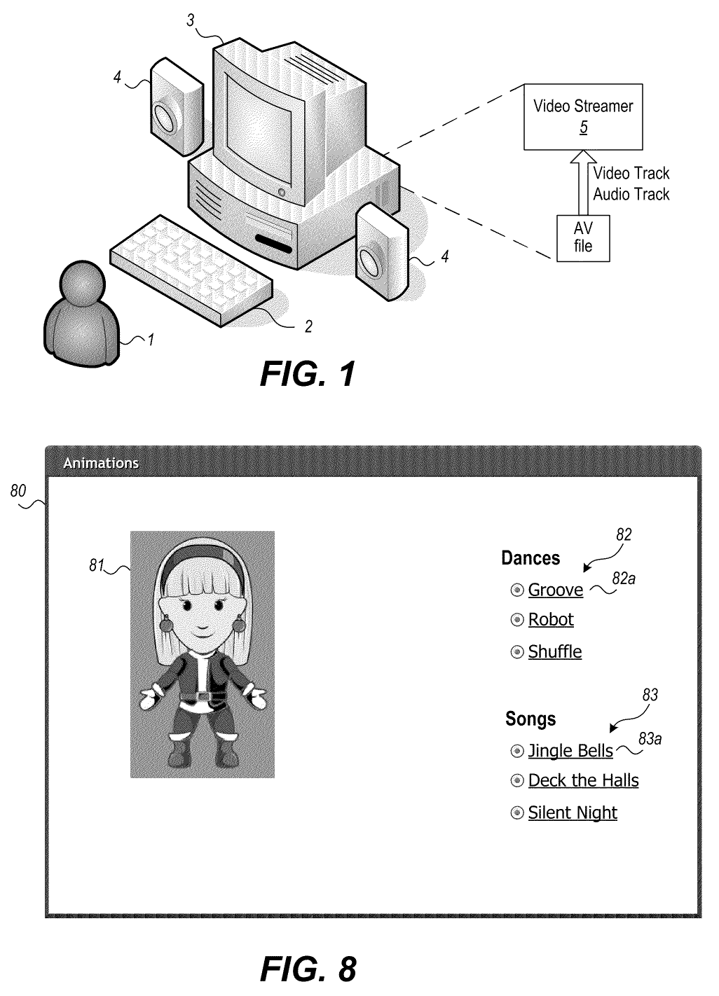

FIG. 1 shows a user 1 viewing an animated video track 6 playing, via a video streamer 5, on a computer screen 3. The video streamer 5 plays an associated audio track over the computer speakers 4. The audio track is synchronized to the video track and are packaged together in an audio-video file playable by the video streamer 5.

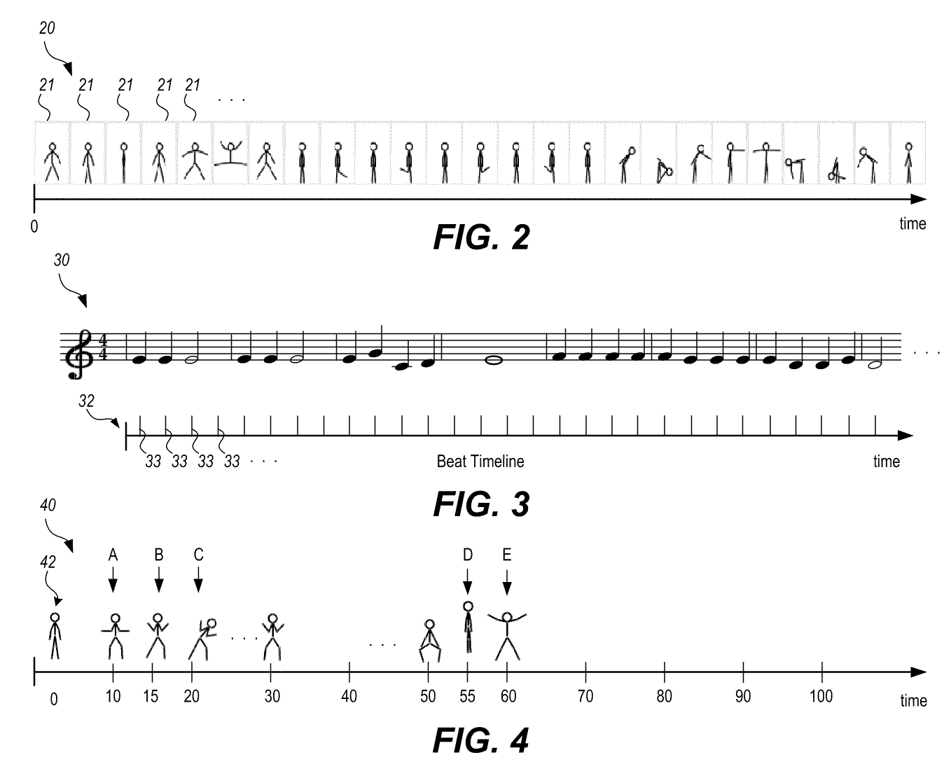

FIG. 2 illustrates a conceptualized view of a video track 20 comprising a series of frames 21 which when displayed sequentially at a high speed, for example by a video streamer 5, result in an animated video. Each frame 20 contains a static image or graphic 21. As used herein, the term “animation” refers to perceived movement generated by rapidly displaying a series of static images.

A video streamer 5 (see FIG. 1) sequentially displays each frame 20 in the video track 20 onto an output display 3 at a specified constant speed, for example, 25 frames per second. Simultaneously, the video streamer 5 outputs the sound from an audio track to the speakers 4. In one embodiment, the video streamer 5 is an Adobe® Flash Player, manufactured by Adobe Systems Inc.

A dance is a choreographed sequence of body movements typically organized by time. Dance moves may be delineated from one to the next by detection of a stop in movement, a change of direction in movement, or an acceleration in movement. For purposes of the present invention, it will be assumed that a dance may be organized into a series of moves that follow a constant beat. The dance beat may be different than that of the beat of the music, as hereinafter discussed.

When an audio track containing music or other sound is played during the display of a video track, it is often desirable to synchronize the sound generated by the audio track to what is actually happening in the video track to make for a more natural viewing and listening experience. Thus, the animation designer must ensure that certain frames of the animation align with certain sounds in the sound track. Embodiments of the present invention include techniques to adjust the number of frames in the video track such that the “animated” action as displayed on the user's computer display appears synchronized with the sound.

It is very well known that music is sound organized by time. A “beat” is herein defined as the basic time unit of a given piece of music. The beat, as herein defined, is therefore the pulse of the musical piece, and the pulse rate is, at least for the purposes of the present invention, constant over the duration of the audio track. While the number of beats per unit time is constant, some beats over the course of the piece of music may be stressed (also called “strong”), some may be unstressed (also called “weak”), and some may even be silent.

FIG. 3 illustrates a musical score 30 of an example musical piece—namely, “Jingle Bells”—with a corresponding beat timeline 32 aligned therebelow. Each vertical line 33 on the beat timeline represents one beat (or pulse). In the example beat timeline 32 of FIG. 3, there are four beats to a measure (as also indicated by the time signature at the beginning of the score). In common Western musical notation, each measure of the score 30 is delineated from the next by a vertical line.

The time units of a dance piece may be different from the time units of a piece of music selected to play simultaneously therewith. Embodiments of the invention include a method and system which determines the total number of frames required in a video track to synchronize the action in the video with the beats of a selected audio track.

Turning now to a specific example, a video track may comprise an animated dance performed by a cartoon character. When played by a video streamer, a dance comprises a plurality of bodily movements performed by the cartoon character. For example, the dance may include a series of movements of the arms and legs of the cartoon character. A dance consists of a complete specification of dancer's body between the beginning of the dance and the end of the dance (normalized to between 0 and 100 in FIG. 4). In animation, an animator need only have the specification of the dancer's body at specified synchronization points over the entire dance. These synchronize points are, for example, the beginning/end points of certain movement, including a stop in movement and a change in speed and/or direction of movement. In between the specified synchronization points, the movement is assumed to occur with the smoothest transition.

In actual implementation of an animation, there is the notion of how long the animation is to be (i.e., its duration in time), and the number of frames per second (fps) that the video streamer is to sequence the frames on the user's display. A frame is generated for each of the specified synchronization points, and given the desired time duration of the video and the specified frames per second (fps), a number of fill frames are generated to produce the visual effect of smoothest transition.

During implementation, the animator designing the dance animation defines a set of synchronization points in the dance wherein the motion of one or more body parts stops, changes direction, and optionally, changes speed. The goal is to get each frame which displays the character at a synchronization point to be displayed in synchronization with a beat of the music in the audio track. For example, FIG. 4 shows a timeline of the synchronization points of a dance 40 to be performed by a cartoon character 42. At 10% into the dance, the cartoon character 42 needs to have its body parts be positioned as shown at point A. At 15% into the dance, the cartoon character needs to have its body parts be positioned as shown at point B. At 25% into the dance, the cartoon character needs to have its body parts be positioned as shown at point C, and at 55% into the dance, the cartoon character needs to have its body parts be positioned as shown at point D. At 60% into the dance, the cartoon character needs to have its body parts be positioned as shown at point E. Only five synchronization points are shown in the dance timeline in FIG. 4 for purposes of simplicity. However, it will be recognized by those skilled in the art that in practice, a single animation (or dance) specification may include many more such synchronization points.

In this illustrative example, as in many such instances in practice, the designated synchronization points may not occur in synchronization with the beats 33 of the selected audio (music) track. That is, frames corresponding to designated synchronization points are not necessarily displayed synchronous to a beat of a selected audio track during play of the video.

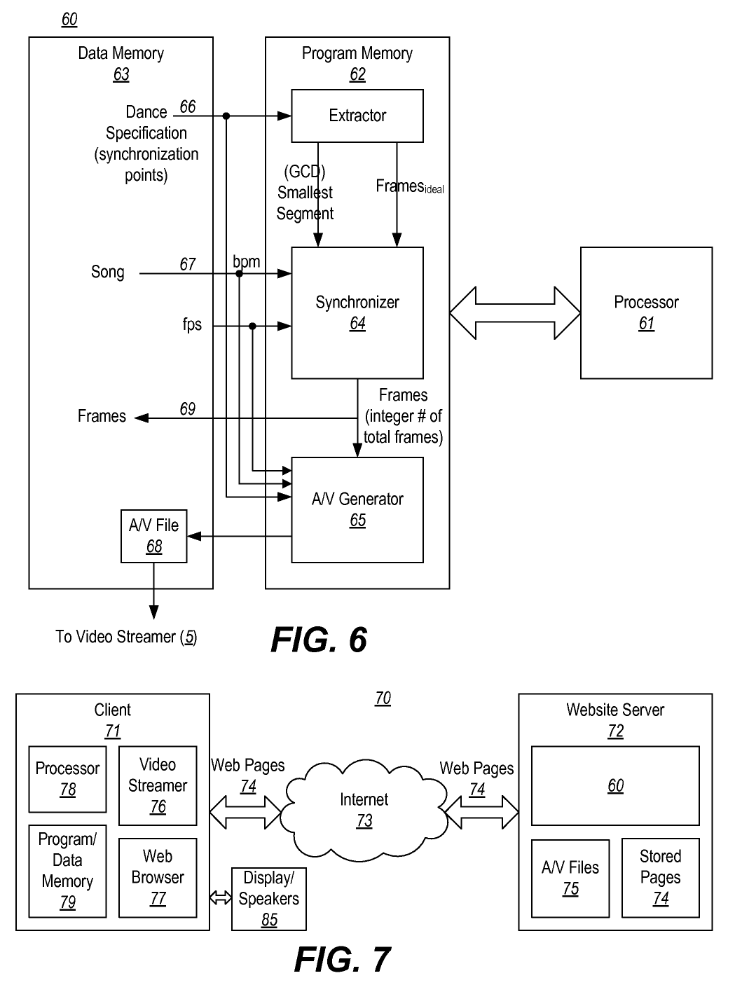

An apparatus (see FIG. 6) in accordance with the invention takes the designated synchronization points A, B, C, D, E of a specified animation (e.g., a dance) and information known about the audio track and the specified animation (e.g., a dance), and generates the total number of frames required in the video track to align the frames containing synchronization points of the dance with beats of the selected audio track.

In order to ensure that the designated synchronization points A, B, C, D, E of the animation fall on beats of the music, the apparatus performs a series of simple estimation maximization steps on the following equation:

fps*frames*segment=a*bps Equation 1

where:

“fps” is the number of frames per time unit in the total animation (in this example, frames per second, or “fps”);

“frames” is the total number of frames in the animation or video track;

“segment” is the lowest common denominator of the percent into the total dance of a all of the synchronization points of the dance;

“a” is an integer; and

“bpm” is the number of beats per time unit in the total music track (in this example, beats per minute, or “bpm”).

The goal is to design an animation or video track to comprise a number of frames such that it appears synchronized (at least at the designated synchronization points A, B, C, D, E) with the beats of the music or sound in the audio track.

As noted in the example of FIG. 4, the distance between the specified synchronization points A, B, C, D, E is not constant. In order to synchronize the beats of the selected audio track with the dance, the beats 33 (see FIG. 3) must line up with the shortest segment of the total dance 40 that is equal to the greatest common denominator of the percentages into the dance of each of the synchronize points A, B, C, D, E. In the illustrative example, the greatest common denominator of 5%, 10%, 25%, 55%, and 60% is 5%. Thus, as long as a beat of the audio track is synchronized with the resulting frame that is displayed 5% into the total video, each respective frame corresponding to each of the synchronization points A, B, C, D, E of the dance 40 will also occur on a beat 33 of the audio track, thus making the dance appear synchronized to the simultaneously output audio track.

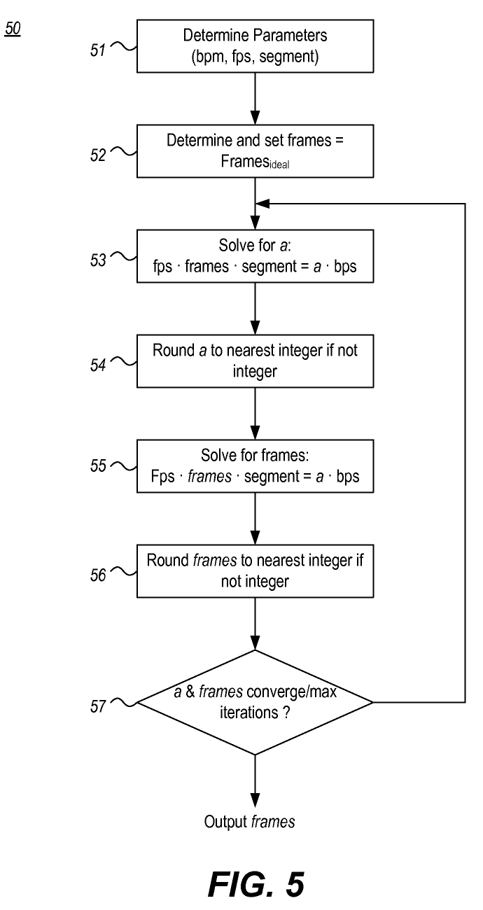

FIG. 5 is a flowchart illustrating an exemplary method 50 for determining the number of frames of animation given the designated synchronization points and selected audio track.

To accomplish this, in step 51 the method 50 first determines the values for the known parameters, including bpm (beats per minute) and fps (frames per second). Bpm is known by the time signature of the score and tempo at which it is played. Fps is determined by the speed at which the video streamer will play the video, which is typically pre-defined for the application and expected hardware of the end user. The value for segment is determined by determining the greatest common denominator of each of the percentages of the positions of the synchronization points A, B, C, D, E in the dance specification 40 relative to the entire dance (normalized to a 0 to 100% scale) (as previously discussed with respect to FIG. 4).

Next, in step 52 the method 50 determines an ideal number for the total number of frames for the video track based on the desired duration of the video track (which should match the audio track in duration) and the known fps for the application. That is, given a video of known duration (total time Tₜₒₜₐₗ in seconds=total time T_{audio} of the audio track), and the specified number of frames per second (fps) that the video streamer will play the file, the ideal number of frames in the video is easily calculated using the equation: Frames_{ideal}=fps*Tₜₒₜₐₗ. The parameter frames is set to Frames_{ideal}.

In step 53, Equation 1 is solved for a to get an approximate value for the number of beats per frame. If the value of a is not an integer, it is rounded to the nearest integer in step 54. In step 55, Equation 1 is then solved for the parameter frames, plugging the new value of a into the equation. In step 56, if frames is not an integer, it is rounded to the nearest integer. The process is repeated until the values converge, or alternatively, after a pre-determined number of iterations in the case of no convergence (detected in step 57).

Once the number of frames is known, an audio-visual file generator (65 in FIG. 6) (for example, a .SWF generator) receives the dance specification 66, the selected audio file 67, the fps specification, and the calculated number of frames 69, and generates an audio-visual file 68 (e.g., a .SWF file) containing an animation of the dance wherein frames corresponding to synchronization points in the dance are synchronized to a beat of the audio track and the frames between the synchronization points implement the smoothest transition between adjacent synchronize point frames.

The audio-visual file 68 may then be played by a video streamer (such as Adobe® Flash Player) and the animation appears synchronized to the audio track.

FIG. 6 is an apparatus for determining the number of frames 69 of animation given the designated synchronization points in the dance specification 66 and selected audio track 67. The apparatus is a synchronizer 64, in the form of a software module comprising computer readable instructions stored in program memory 62 which are executed by a processor 61 to perform the method of FIG. 5. Data memory 63 stores synchronization points A, B, C, D, E, of dances, audio tracks, and parameters need to calculate the total number of frames for the video track to synchronize the audio track to the synchronization points A, B, C, D, E of the dance 40. The synchronizer 64 receives the bpm, fps, Frames_{ideal}, and segment parameters and generates the total number of frames 69 required to synchronize the audio track to the video track.

The apparatus also includes an audio-visual generator 65 which receives the total number of frames 69 required to synchronize the audio track to the video track, the fps parameter, the dance specification 66, and the audio track 67, and generates an audio-visual file 68 that may be played by a video streamer 5. In an embodiment, the audio-visual generator 65 is a .SWF generator which generates .SWF files that are readable and playable by an Adobe® Flash Player, and the video streamer 5 is an Adobe® Flash Player.

FIG. 7 is a block diagram of a computerized environment embodying one implementation of the invention. The system 70 includes a processor 78, program memory 79, data memory 79, user input means such as, but not limited to, a mouse and keyboard (not shown, but see FIG. 1), and user output means including at least a display and speakers 85. The program memory 79 stores computer readable instructions which, when executed by the processor 78, display a set of choices of animation content to be displayed. In one embodiment, the displayed set of choices of animation content to be displayed may be titles of dances to be performed by a cartoon character (see FIG. 8). In alternative embodiments, the displayed set of choices of animation content may be any type of action, for example, talking or singing. The animation content is not limited to action by cartoon characters, but may include action by actual filmed people and animals, or even action not including any visible live creatures (for example, tidal action). Thus, the content of the animation itself is not limited to any actual subject matter, but need only have some action having defined designated synchronization points that should be synchronized to a beat of the sound track. Finally, the set of choices need not even be more than one choice. That is, there may only be one animation content that may be dynamically synchronized with more than one sound track.

The program memory 79 also stores computer readable instructions which, when executed by the processor, receives a selection of an animation content to be synchronized. The selection may be transmitted via a web browser 77 to a server 72, discussed hereinafter.

The program memory 79 also stores computer readable instructions which, when executed by the processor, displays a set of choices of sound tracks to synchronize to the selected animation content. In an embodiment, the set of choices of sound tracks are titles of songs which correspond to digital sound recordings. In one embodiment, the set of choices comprise links to digital sound tracks to allow a user to listen to the sound track prior to submitting a final selection.

The program memory 79 also stores computer readable instructions which, when executed by the processor, receives a selection of a sound track to be synchronized with a selected animation content. The selection may be transmitted via a web browser 77 to a server 72, discussed hereinafter.

The program memory 79 also stores computer readable instructions which implements the synchronizer and audio-visual generator of FIG. 6.

The system may be implemented as a stand-alone computer program (not shown), or alternatively, could be distributed across several networked computers. For example, FIG. 7 illustrates a client-server environment, for example as implemented in an online electronic greeting card website. The client 71 is a customer's (or other user's) computer system, and the server 72 is an online electronic greeting card web server. The client 71 connects to the server 72 via the Internet 73 or other type of public or private network using any of multiple well-known networking protocols.

The server 72 hosts a website which the client 71 connects to over the network 73. The server serves web pages 74 to the client 71 which are displayed on the client's computer display. FIG. 8 shows an exemplary web page 80 displaying a cartoon character 81 and a list of dance titles 82 and a list of song titles 83 allowing the user to select a dance title and a song title to animate the cartoon character. Of course, it will be understood the any number of web pages may be displayed to lead up to the selection of the animation content and the song title. In an alternative embodiment, the dance and/or song selections may be randomly selected by the computer. In another alternative embodiment, the user may only select the song title.

Upon selection of the dance title 82a and song title 83a, the server 72 performs synchronization of the selected dance corresponding to the selected dance title 82a with the audio track corresponding to the selected song title 83a, and generates an audio-video file 75. The audio-visual file 75 is downloaded to the client 71 and played by the client's video streamer 76, The animation appears on the client's display synchronized to the audio track heard over the client's speakers.

The entire process can be implemented dynamically to allow a user to select a particular animation content (e.g., a particular dance to be performed by a cartoon character) from a set of choices of animation content, and a desired sound track (e.g., a digital recording of a song or other sound having a pulsed beat) from a set of choices of sound tracks, and to have a computerized environment such as a web server or personal computer generate the animation frames between the synchronization points without any input from the user other than the selection of the animation content and the sound track. The system therefore allows a user to select a music track and the web server to dynamically insert an appropriate number of animation frames between each designated synchronization point so as to dynamically synchronize the selected music track with the synchronization points in the animation.

In an alternative embodiment, many of the calculations performed by the synchronizer and audio-visual file generator can be performed once, and the resulting audio-visual files merely stored by the server and served when the corresponding dance and song titles are selected by the user.

What is claimed is:

1. A computer implemented method for determining a number of frames of animation given a set of synchronization points in an animation specification and a selected audio track, comprising:
obtaining a fixed number of beats per time unit;
obtaining a fixed number of frames per time unit;
obtaining a segment size corresponding to a greatest common denominator of each of the percentages of the positions of the synchronization points in the animation specification relative to the entire animation specification;
obtaining an ideal number for the total number of frames for the video track based on the desired duration of the video track and the fixed number of frames per time unit;
performing estimation maximization to find a total number of frames required in the video track such that each of the synchronization points aligns with a beat of the selected audio track when the video track and the selected audio track are played simultaneously.

2. The method of claim 1, further comprising:
Generating an audio-video file comprising the video track having the total number of frames and the selected audio track.
